(19) United States
(12) Patent Application Publication
(10) Pub. No.: US 2009/0077248 A1
(43) Pub. Date: Mar. 19, 2009

(54) BALANCING ACCESS TO SHARED RESOURCES

(75) Inventors: Antonio Castellucci, Rome (IT); Roberto Guarda, Pomezia (IT)

Correspondence Address: IBM Corp.;(Austin IP Law), c/o Johnson & Associates, P.O. Box 90698, Austin, TX, 78709-0698, US

(73) Assignee: INTERNATIONAL BUSINESS MACHINES CORPORATION, Armonk, NY (US)

(21) Appl. No.: 12/175,738

(22) Filed: Jul. 18, 2008

(30) Foreign Application Priority Data
Sep. 14, 2007 (FR) 07116398.4

(51) Int. Cl. G06F 15/16

(52) U.S. Cl. 709/229

(57) ABSTRACT

Methods, systems, and computer program products for accessing a shared resource in a data processing system by a plurality of clients are disclosed. In one example, a privilege limit for a privileged use of the shared resource is associated a with each client. A use indicator is measured for each client, which relates to use of the shared resource by the respective client. When a critical condition of the shared resource is detected, the access granted to at least one client is released. Access may then be granted to another client.

### CROSS REFERENCE TO RELATED APPLICATIONS

This application claims priority under 35 U.S.C. §119 to co-pending, commonly owned French patent application serial number 07116398.4 filed on Sep. 14, 2007, entitled “METHOD, SYSTEM AND COMPUTER PROGRAM FOR BALANCING THE ACCESS TO SHARED RESOURCES WITH CREDIT-BASED TOKENS.”

### BACKGROUND

This disclosure relates to the field of data processing. In particular, this disclosure relates to access to shared resources in a data processing system.

Shared resources are commonplace in modern data processing systems. Generally speaking, a shared resource consists of any (logical and/or physical) component, which can be accessed by multiple exploiters in turn. An example of a shared resource is a server computer (or simply server), which offers a corresponding service to a large number of users accessing the server using their client computers (or simply clients). A typical application of the above-described client/server structure is in the Service Oriented Architecture (SOA) environment, for example, for the implementation of services of the Digital Asset Management (DAM) type. Some available services are free of charge. However, the exploitation of most of the services is subject to some sort of payment by the users.

### BRIEF SUMMARY

A method is provided for balancing access to a shared resource in a data processing system by a plurality of exploiter entities, the method including associating a privilege limit for a privileged use of the shared resource with each one of a set of active entities, measuring a use indicator for each active entity, the use indicator relating to actual use of the shared resource by the respective active entity, detecting a critical condition of the shared resource, upon receiving an access request for access to the shared resource by a new one of the active entities, releasing the access granted to at least one of a set of active entities currently accessing the shared resource, and granting access to the new active entity.

One embodiment provides a computer program product for balancing access to a shared resource in a data processing system by a plurality of exploiter entities, the computer program product including a computer-usable medium having computer usable program code embodied therewith, the computer usable program code including computer usable program code configured to associate a privilege limit for a privileged use of the shared resource with each one of a set of active entities, measure a use indicator for each active entity, the use indicator relating to actual use of the shared resource by the respective active entity, detect a critical condition of the shared resource, release the access granted to at least one of a set of active entities currently accessing the shared resource upon receiving an access request for access to the shared resource by a new one of the active entities, and grant access to the new active entity using the one or more servers.

One embodiment provides a dispatching system for balancing access to a shared resource in a data processing system by a plurality of exploiter entities, the dispatching system including one or more servers configured to receive requests for access to the shared resource and to return corresponding responses, one or more storage devices configured to store information, a dispatcher coupled to the one or more servers and to the one or more storage devices, wherein the dispatcher is configured to associate a privilege limit for a privileged use of the shared resource with each one of a set of active entities, wherein the dispatcher is configured to measure a use indicator for each active entity, the use indicator relating to actual use of the shared resource by the respective active entity, wherein the dispatcher is configured to detect a critical condition of the shared resource, wherein the dispatcher is configured to release the access granted to at least one of a set of active entities currently accessing the shared resource in response to the one or more servers receiving an access request for access to the shared resource by a new one of the active entities, and wherein the dispatcher is configured to grant access to the new active entity.

### BRIEF DESCRIPTION OF THE SEVERAL VIEWS OF THE DRAWINGS

The disclosure is illustrated by way of example and not limitation in the figures of the accompanying drawings, in which like references indicate similar elements and in which:

FIG. 1 is a schematic block diagram of an embodiment of a data processing system,

FIGS. 2-3 are explanatory time diagrams of an exemplary scenario relating to an embodiment of a data processing system,

FIG. 4 shows an example of software components that can be used to implement an embodiment of a data processing system, and

FIGS. 5A-5B show a diagram describing the flow of activities relating to an implementation of an embodiment of a data processing system.

### DETAILED DESCRIPTION

Generally, the present disclosure is based on the idea of defining a limited privileged use of a shared resource (for example, in the form of a credit reducing over time) for forcing the release access to the resource. In one example, a method is disclosed for accessing a shared resource in a data processing system (such as a service) by a plurality of exploiter entities (such as clients). The method starts with associating a privilege limit for a privileged use of the shared resource with each one of a set of active entities (for example, in the form of a credit). A use indicator is measured for each active entity. The use indicator relates to actual use of the shared resource by the active entity(ies). The method continues by receiving an access request for access to the shared resource by a new one of the active entities. The method detects a critical condition of the shared resource, such as when no handle for exploiting the service is available. The access granted to at least one of a set of enabled entities is released. This happens in response to the access request in the critical condition with the use indicator of the new active entity that does not reach the privilege limit. The access is then granted to the new active entity. In one example, the access to be released is selected as the one having the corresponding use indicator closest to the privilege limit (for example, with the lowest credit). In one example, the method is based on the use of a token (for authorizing the access to the corresponding client). The token is associated with a profile for saving the context information of the client among different sessions.

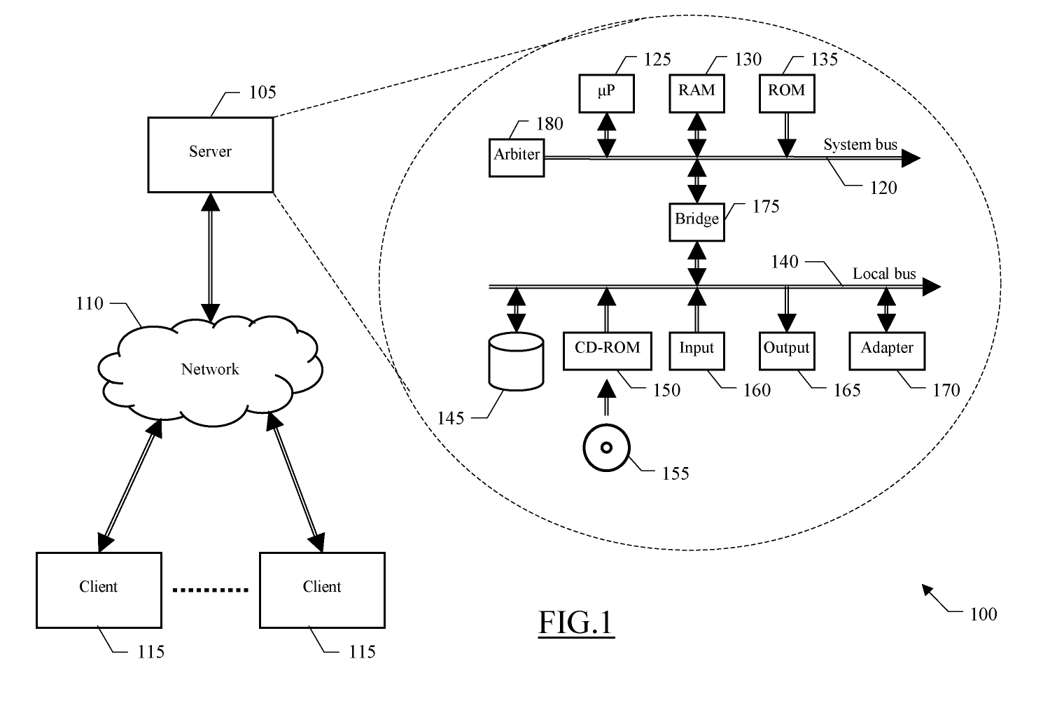

With reference to FIG. 1, a distributed data processing system 100 is illustrated. The system 100 has client/server architecture, typically based on the Internet. The Internet consists of millions of servers 105 (only one is shown in FIG. 1), which are interconnected through a global communication network 110. Each server 105 offers one or more services. Users of clients 115 access the server 105 through computers (not shown in FIG. 1) operating as access providers for the Internet, in order to exploit the offered services.

In one example, the services conform to the SOA specification. In this example, each service consists of a stand-alone basic task, which may be invoked through a well-defined interface, independent of its underlying implementation. The SOA environment is intrinsically stateless, meaning that every invocation of the service is self-contained (without any knowledge of the previous processing). The services may be of the DAM type, supporting the acquisition, storage and retrieval of digital assets (such as photographs, videos, music, and the like). For example, each service may be implemented with a legacy application that is wrapped to work in the SOA environment. The legacy application may instead be stateful, meaning that context information of each user is maintained for different processing. Typically, the context information includes personal data (relating to the user and/or the corresponding client) and status data (relating to a current progress of the processing). Generally, the personal data is collected using a handshaking procedure, which allows verifying the identity of the user and his/her authorization to exploit the desired service.

In one example, the server 105 consists of a computer that is formed by several units that are coupled in parallel to a system bus 120. In detail, one or more microprocessors (μP) 125 control operation of the server 105. A RAM 130 is directly used as a working memory by the microprocessors 125, and a ROM 135 stores basic code for a bootstrap of the server 105. Several peripheral units are clustered around a local bus 140 (using respective interfaces). Particularly, a mass memory consists of one or more hard-disks 145 and drives 150 for reading CD-ROMs 155 or other media. Moreover, the server 105 includes input units 160 (for example, a keyboard and a mouse), and output units 165 (for example, a monitor and a printer). An adapter 170 is used to couple the server 105 to the network 110. A bridge unit 175 interfaces the system bus 120 with the local bus 140. Each microprocessor 125 and the bridge unit 175 can operate as master agents requesting an access to the system bus 120 for transmitting information. An arbiter 180 manages the granting of the access with mutual exclusion to the system bus 120.

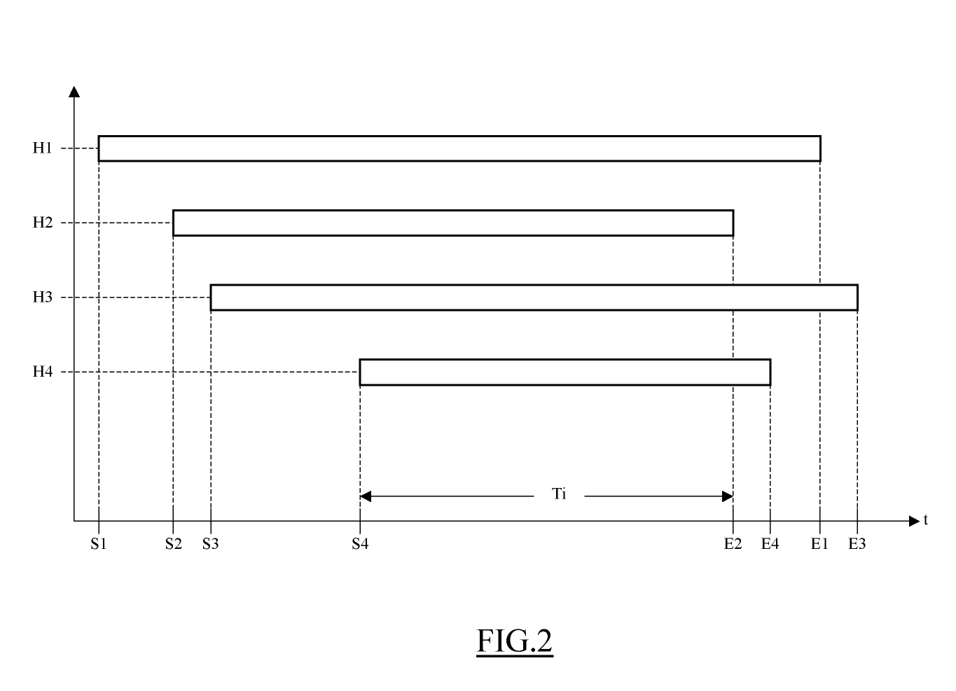

An exemplary scenario relating to an activity over time (t) of generic users accessing the above-mentioned server is illustrated in FIG. 2. For each (enabled) user currently exploiting a service offered by the server, a corresponding working session is established with the allocation of a connection handle, which is used to access the context information of the user. The user interacts with the server by submitting a series of service requests, for example, to upload, search or download specific digital assets. The server processes each service request by exploiting the context information of the user, which is then updated accordingly. For example, this may involve storing uploaded digital assets, searching available digital assets, or retrieving desired digital assets and charging the user for every performed operation. The server then returns a corresponding response to the user. Typically, the response consists of a return code of the uploading, a list of the digital assets satisfying the desired search, or the selected digital assets. The handle is released, with the corresponding context information that is discarded, when the user or the server closes the session (for example, after the user has obtained all the desired information or an expense limit has been reached). In any case, the handle is released automatically when the user remains inactive without interacting with the server (i.e., with no service request that is submitted after the handle has been allocated or after the response to a previous service request has been received) for a period longer than a predefined time-out Lh (such as 15-30 min., for example). For example, FIG. 2 shows four handles H1-H4 that last from a start time S1-S4 to an end time E1-E4, respectively.

In one example, the server can manage a maximum number of handles concurrently (for example, on the order of hundreds). Once this maximum number of handles has been reached, no further handles can be allocated for new users that wish to exploit the service. Assuming, in the very simplified example shown in FIG. 2, that the maximum number of handles is four, this limit is reached at the time S4. Therefore, any service requests by new users after the time S4 would be refused, and the server would remain unavailable (for the new users) until one of the handles H1-H4 is released. In the example shown in FIG. 2, this unavailability time Ti would last until the time E2, when the handle H2 is released.

In one embodiment, a privileged use of the server is granted to each (active) user. However, the privileged use is limited according to the actual use of the server that has been made by the user. For example, this limit is defined by a credit that is reduced every time the user receives a response to a service request submitted to the server. The credits are used to balance the exploitation of the service when no handle is available, because the maximum number has been reached. In this case, if a service request is submitted by a new user with corresponding credit that is not exhausted, the server forces the release of a handle currently allocated to another user. The released handle is then allocated to the new user.

The above-mentioned privileged use (for forcing the release of the handles) strongly increases the availability of the server. This advantage is particularly evident in services (such as of the DAM type), which should guarantee their exploitation to the largest possible number of different users in any situation (for example, even in the case of a peak of requests). However, the limit being set for this privileged use (by the credit reducing over time) avoids any excessive overload of the server, which would be caused by continual releases of the handles. In other words, the proposed example provides an excellent tradeoff between the opposed desirability of high availability of the server and low overhead.

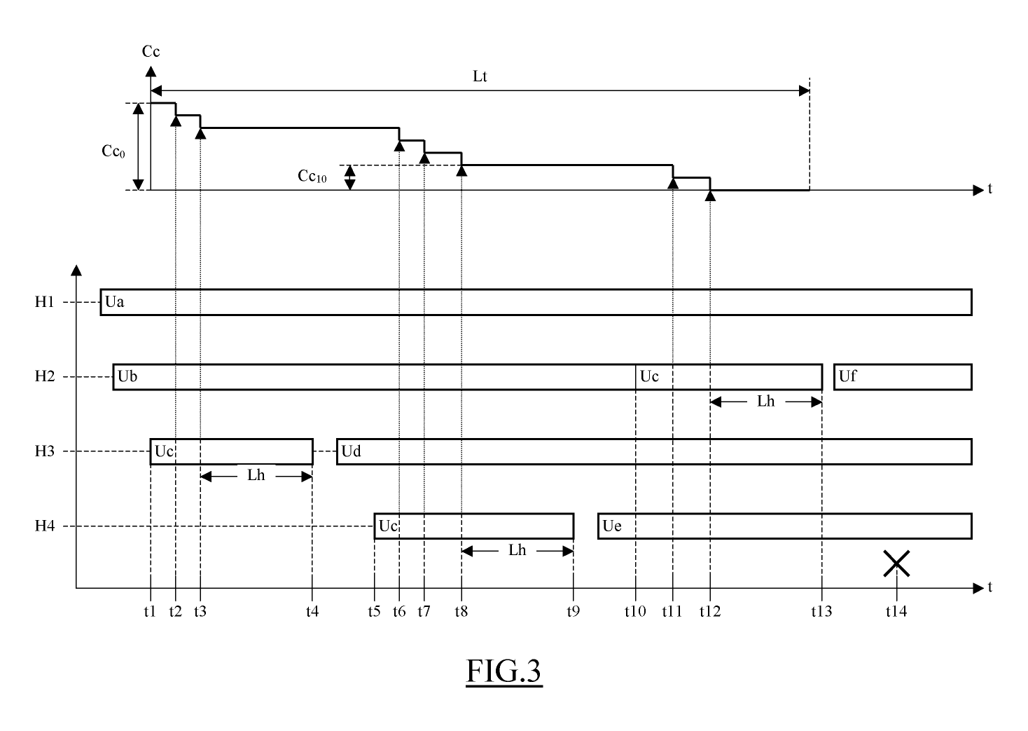

For example, as shown in FIG. 3, let us consider a situation where the handle H1 is allocated to a user Ua, and the handle H2 is allocated to a user Ub. At the time t1, a new user Uc submits a connection request for starting exploiting the service. In response thereto, the server performs a handshaking procedure to verify the identity of the user Uc and his/her authorization. Assuming that the handshaking procedure succeeds, the user Uc is granted access to the server.

For this purpose, the server creates a new access token Kc for the user Uc. The token Kc is used to access a profile, which stores the personal data of the user Uc that is collected during the handshaking procedure. The profile also includes the current value of the credit Cc that is assigned to the user Uc. The credit Cc is initialized to a starting value Cc0 (such as on the order of some tens, for example).

The server immediately allocates a handle for the token Kc if it is possible, with the information that is saved in the corresponding profile. In the example of FIG. 3, the handle H3 is available so that it can be allocated to the token Kc. For this purpose, the context information of the handle is initialized with the personal data of the user Uc that is loaded from the profile of the token Kc. This additional feature tries to make a handle ready for a first service request, which is very likely to be submitted in a short time by a user that has just been granted the access to the server.

Whenever the user Uc submits service requests to the server, the service requests are processed using the handle H3 (associated with his/her token Kc), which returns corresponding responses to the user Uc (at the time t2 and t3 in the example shown in FIG. 3). The return of every response to the user Uc also causes the reduction by one of the corresponding credit Cc. The handle H3 is then released at the time t4, since the time-out Lh has been reached without the submission of any further service request by the user Uc. However, the context information of the handle H3 is saved into the profile of the token Kc before being discarded. The same handle H3 is then allocated to a further user Ud.

The time-out mechanism for the handles reduces the probability of contention on the server, since the handles are released when they should not be necessary any longer, for example, because the corresponding users have already obtained all the desired responses from the server but have forgotten to close the sessions. In this way, the need of implementing the above-mentioned procedure for forcing the release of the handles is reduced.

Later on, at the time t5, the user Uc submits another service request to the server. In this case, no handle is allocated for his/her token Kc. Therefore, the server tries to allocate a handle for the token Kc. In the situation at issue, the handle H4 is available so that it can be allocated to the token Kc. For this purpose, the context information of the user Uc is reloaded from the profile of the token Kc. In this way, the information is immediately available, without any overload of the server for its collection. As above, the user Uc submits service requests that are processed using the handle H4. Corresponding responses are returned to the user Uc at the time t6, t7 and t8 in the example shown in FIG. 3, with the credit Cc that is reduced accordingly. The handle H4 is then released at the time t9 when the time-out Lh is reached, with the context information of the handle H4 that is saved into the profile of the token Kc. The same handle H4 is then allocated to a further user Ue.

In this way, the token Kc is completely de-coupled from the handles H1-H4 (since different handles H1-H4 can be used for the same token Kc over time). In any case, the context information saved in the profile of the token Kc, which is loaded for the corresponding handle at its creation, provides continuity between different service requests that are submitted to the server, thereby avoiding the startup costs that would instead being needed to recollect the context information using the handshaking procedure.

At the time t10, the user Uc submits another service request to the server. In this case as well, no handle is allocated for his/her token Kc. However, no handle is available, since the maximum number of four has already been reached. Nevertheless, since the credit Cc is not exhausted, one of the handles H1-H4 is released and allocated to the token Kc. In the example of FIG. 3, the handle H2 (currently allocated to the user Ub) is released and allocated to the token Kc.

In one example, the handle to be released is selected according to the credits of the corresponding users. In one example, the server releases the handle whose user has the lowest credit. This additional feature avoids penalizing the users that have just been granted the access to the server.

As above, the user Uc submits service requests that are processed using the handle H2. Corresponding responses are returned to the user Uc at times t11 and t12, in the example of FIG. 3. The credit Cc is reduced accordingly, down to zero at time t12. The handle H2 is then released at the time t13 when the time-out Lh is reached, with the context information of the handle H2 that is saved into the profile of the token Kc. The same handle H2 is then allocated to a further user Uf.

Later on (at the time t14), the user Uc submits another service request to the server. In this case as well, no handle is allocated for his/her token Kc and no further handle is available. However, the credit Cc is now exhausted. Therefore, the processing of the service request by the server is refused, as denoted by a cross in FIG. 3.

It is evident that the credits are not used to enable/disable the access to the server by the corresponding users as in the example prepaid credits, wherein each user is allowed to access the server only until his/her credit is not exhausted. Conversely, the credits are completely opaque to the server when one or more handles are still available (with the access to the server that can be either free or controlled using any payment technique). The credits are instead taken into account to balance the access to the server only when no handle is available.

In one example, as shown in FIG. 3, the token Kc expires after a predefined time-out Lt, typically far longer than the time-out Lh for the handles (for example, on the order of days). In this example, the token Kc is released. This involves discarding the corresponding profile and releasing the handle associated thereto (if any). For this purpose, it is possible to store a timestamp indicative of the creation time of the token Kc into its profile. Any further service request that is submitted after the expiration of the token Kc is then refused, with the user Uc that can request to re-access the server by repeating the handshaking procedure described above for verifying his/her identity and authorization again, and then creating a new token for the same user Uc. This additional feature increases the security of the proposed solution, since it limits the access that has been granted to the server temporally (for the same verification of each user).

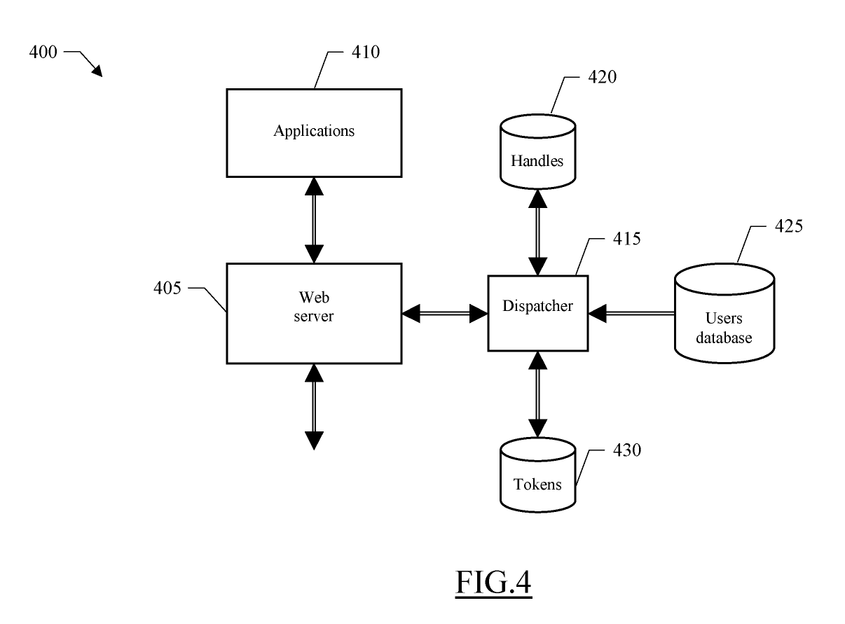

FIG. 4 is an example of the main software components 400 that can be used to implement an embodiment of the above-described solution. The components 400 may be used in any desired way, for example, in a dispatch system, a service, a computer program product, etc. The information (e.g., programs and data) is typically stored on the hard-disk and loaded (at least partially) into the working memory of the server when the programs are running, together with an operating system and other application programs (not shown in FIG. 4). The programs are initially installed onto the hard disk, for example, from CD-ROM.

In one example, a web server 405 is used to allow different users to interact with the server through browsers running on corresponding clients (not shown in FIG. 4). In one example, the web server 405 receives (connection/service) requests for the services offered by one or more web applications 410 (of the DAM type in the example in FIG. 4), and it returns the corresponding responses.

The web server 405 interfaces with a dispatcher 415, which manages all the sessions on the server. For this purpose, the dispatcher 415 controls a repository 420, which stores each allocated handle with the corresponding context information. A user database 425, which includes the personal data of all the users that are authorized to access the server, is exploited by the dispatcher 415 to verify each user during the handshaking procedure. The dispatcher 415 also controls a further repository 430, which stores each token in use with the corresponding profile.

In one example of a dispatching system, the dispatcher 415 is configured to associate a privilege limit for a privileged use of a shared resource with one or more clients, to measure a use indicator for each active client, to detect a critical condition of the shared resource, to release the access granted to active client, and to grant access to a new client.

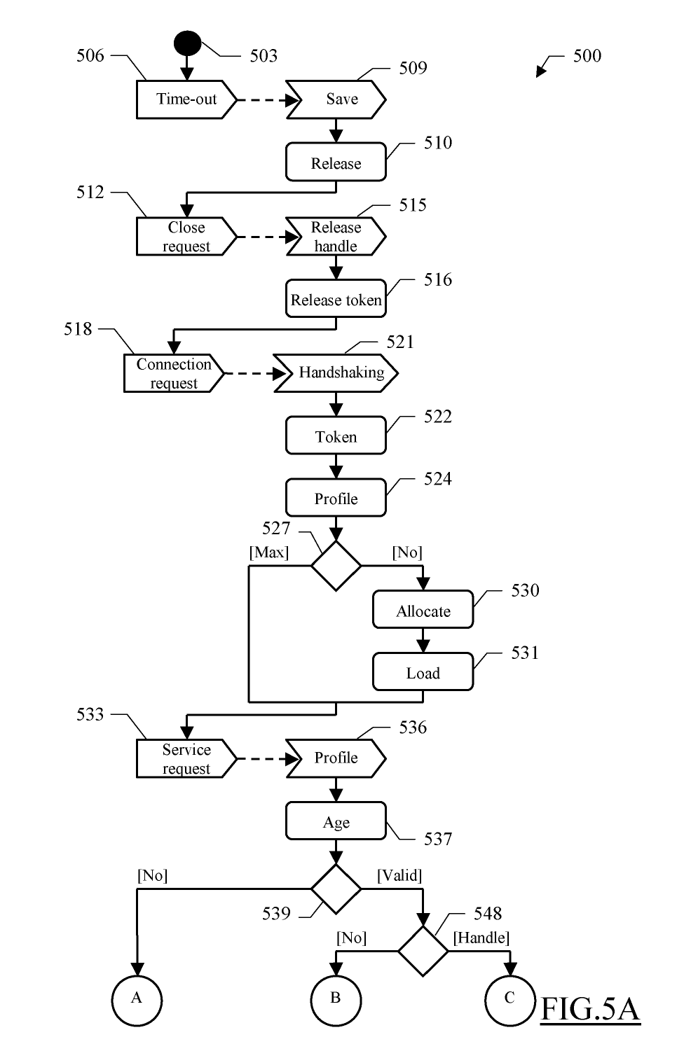

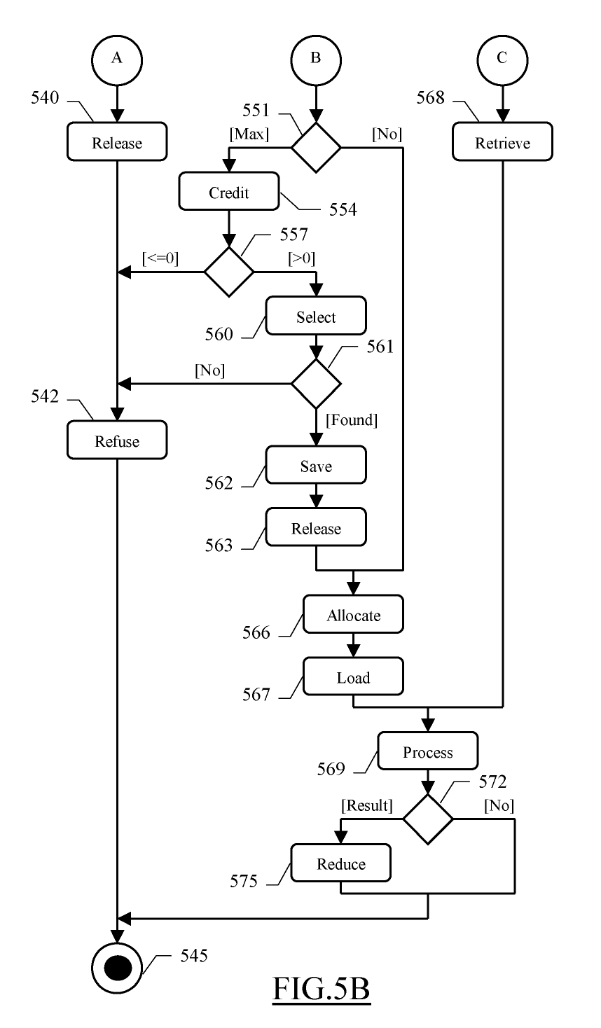

Considering now FIG. 5A-5B, the logic flow of an exemplary process that can be implemented in the above-described system (to control the accesses to the server) is represented with a method 500. The method begins at the black start circle 503 and then passes to block 506 whenever the time-out Lh for any handle expires. For example, this result may be achieved using a counter for each handle. The counter continuously runs in the background, but is reset whenever a service request for the handle is submitted by the corresponding user. When the time-out expires, the context information of the handle is saved into the profile of the corresponding token at block 509. The handle is then released at block 510, with its context information that is discarded.

With reference to block 512, the method passes to block 515 whenever the server receives a request from a user for closing the corresponding access by passing the token as a parameter. In response, the handle associated with the token in the corresponding profile, if any, is released, by discarding its context information. The method proceeds to block 516, where the token can now be released, with the corresponding profile that is discarded.

Moving to block 518, the server receives a connection request from a new user. The flow of activity then passes to block 521, where a handshaking procedure is performed to verify the identity of the user and his/her authorization. Assuming that the handshaking procedure succeeds, the server at block 522 creates a new token for the user. At the same time, the corresponding credit is initialized to the starting value and the timestamp of the token is set to the current time. Continuing to block 524, the corresponding profile is populated with the personal data of the user (collected during the handshaking procedure).

A test is now performed at block 527 to determine whether any handle is available (e.g., whether the maximum number has not been reached). If so, a handle is allocated for the token at block 530 with an indication of the allocated handle that is added to the corresponding profile. Continuing to block 531, the context information of the handle is initialized with the personal data of the user that is loaded from the profile of the token. The method then continues to block 533. The same point is also reached directly from block 527 when no handle is available.

Every time the server at block 533 receives a service request from a generic user (together with the assigned token), the flow of activity passes to block 536. In this phase, the server retrieves the profile of the received token. The time elapsed from the creation of the token (as indicated by the time-stamp in its profile) is then compared with the time-out Lt at block 537. The status of the token is now verified at block 539. If the token has expired (e.g., if the time elapsed from its creation exceeds the time-out Lt), the server at block 540 releases the token (together with the possible handle associated therewith). The service request is then refused at block 542 (with a corresponding error message that is returned to the user). The method ends at the concentric white/black stop circles 545.

Conversely, when the token is still valid the server verifies at block 548 whether a handle is associated with the token (as indicated in its profile). If no handle is found, a test is performed at block 551 to determine whether the maximum number of handles has been reached. If so, the server at block 554 retrieves the credit of the user from the profile of the token. The method then continues to block 557, where the server verifies the credit remaining to the user. If the credit is exhausted (i.e., lower than or equal to zero), the service request is again refused at block 542, with the method that ends at the stop circles 545.

On the contrary (i.e., when the credit is higher than zero), the handle allocated to the user with the lowest credit is selected at block 560. In other words, the release may be conditioned on a releasing condition, such as credit level, in activity, etc., for example. In one example, the selection is restricted to the handles associated with users having the inactivity time higher than a grant period (e.g., lower than the time-out Lh). This grant period represents the typical maximum inactivity time of the users that are still alive, since they have not obtained yet all the desired responses from the server (so that further service requests are likely to be submitted later on). For example, the inactivity time below the grant period may correspond to the choice of the service requests to be submitted, to the playback of the received digital assets, and the like. A test is then made at block 561 to determine whether a handle has been found. If not, the service request is again refused at block 542. The method ends at the concentric white/black stop circles 545. Conversely, the context information of the selected handle is saved into the profile of the corresponding token at block 562. The selected handle is then released at block 563 (with its context information that is discarded).

The flow of activity now continues to block 566. The same point is also reached directly from block 551 when one or more handles are still available (since their maximum number has not been reached yet). In this phase, a new handle is allocated for the token (with an indication of the allocated handle that is added to the corresponding profile). Continuing to block 567, the context information of the handle is directly loaded from the profile of the token. The method then continues to block 569. Referring back to block 548, when a handle is already associated with the token, the corresponding context information is retrieved at block 568. In this case as well, the method then continues to block 569.

At this point, the service request that was submitted by the user is processed. For this purpose, the server exploits the context information of the corresponding handle, which is then updated accordingly (if necessary).

The flow of activity then branches at block 572 according to the outcome of the service request. If the processing of the service request was successful (with the corresponding result returned to the user), the credit of the user is reduced at block 575 in the profile of the token. The method then ends at the stop circles 545. The same point is also reached directly from block 572.

Naturally, in order to satisfy local and specific requirements, a person skilled in the art may apply to the solution described above many logical and/or physical modifications and alterations. More specifically, although the disclosure has been described with a certain degree of particularity with reference to embodiment(s) thereof, it should be understood that various omissions, substitutions and changes in the form and details as well as other embodiments are possible. Particularly, the proposed solution may even be practiced without the specific details (such as the numerical examples) set forth in the preceding description to provide a more thorough understanding thereof. Conversely, well-known features may have been omitted or simplified in order not to obscure the description with unnecessary particulars. Moreover, it is expressly intended that specific elements and/or method steps described in connection with any disclosed embodiment may be incorporated in any other embodiment as a matter of general design choice.

The proposed solution lends itself to be implemented with an equivalent method (by using similar steps, removing some steps being non-essential, or adding further optional steps). Moreover, the steps may be performed in a different order, concurrently or in an interleaved way (at least in part).

Even though reference has been made to a credit (consisting of an integer value that is decreased every time a response is returned to the user), this is not to be intended in a limitative manner. For example, similar considerations apply if a counter is used for counting the number of times that a response is returned to the user (where the credit exhausts when the counter reaches a predefined value). More generally, any other limit for a privileged use of the server may be taken into account, for example, based on the number of service requests that have been processed (independently of their outcome), on a connection time, on a consumption of the service, and the like. Moreover, the proposed credit may be granted either to all the users indiscriminately or only to a subset thereof.

Similar considerations apply if the maximum number of handles is defined in another way (for example, changing dynamically during the day). However, the proposed solution lends itself to be applied in response to the detection of different critical conditions, such as, for example, when the time needed to find the server available exceeds an acceptable value, or when the quality of the service falls below a limit to be guaranteed.

In different embodiments (when other critical conditions are detected), the possibility of forcing the release of two or more handles, when a further service request is received from a user whose credit is not exhausted, is not excluded. In any case, the handle to be released may be selected according to different criteria—even independently of the corresponding credit. For example, it is possible to release the handle associated with the user having the longest inactivity time.

In an alternative implementation, the forced release of the handles may be unconditioned, so that every service request that is submitted by a new user with credit that is not exhausted (after reaching the maximum number of handles) is served.

Although the proposed solution has been described with reference to the SOA services (including services of the DAM type), this is not to be interpreted in a limitative manner. Indeed, similar considerations apply to other SOA services (for example, for online instant messaging applications), or to services based on any other architecture (for example, conforming to the CORBA specification). More generally, the proposed solution lends itself to be applied to manage the access to any other logical and/or physical shared resource (such as files, databases, disks, printers, scanners, and the like) by whatever logical and/or physical exploiter entities (such as operating systems, software applications, routers, switches, and the like).

Likewise, any other context information may be used to provide the desired service in any other kind of working sessions (with equivalent handles for their management). In any case, nothing prevents applying the same solution to services of the stateless type.

Moreover, it is possible to monitor the (in)activity of each user in a different way. For example, the inactivity time may be measured in another way (such as by filtering sporadic service requests), or it may be replaced by any similar indicator (such as equal to the incremental inactivity time of the user during the whole access to the server). However, nothing prevents maintaining each handle allocated, independently of the activity of the corresponding user, until it is not required by other users after reaching the maximum number of handles.

Alternatively, the forced release of the handles may be conditioned in any other way (for example, by restricting it to the users having credits lower than the one of the new user).

Likewise, it is possible to collect the context information with any other procedure (such as requesting the user to enter his/her personal data). The context information may be stored in any equivalent structure (even of the distributed type). Moreover, it should be noted that the tokens may be replaced with any equivalent element for authorizing the exploitation of the service (for example, by simply flagging an identifier of each authorized user accordingly on the server). Likewise, the profiles may be replaced with any equivalent structures, or they may be maintained synchronized with the context information of the corresponding handles in real-time (and not only when the handles are released).

In an alternative embodiment, the tokens may be released according to any other policy (for example, when the consumption of the service reaches a predefined limit). In any case, the use of tokens without any expiration may be used (for example, without strict security requirements).

The proposed service may be implemented by any equivalent service provider, such as consisting of a cluster of servers. In any case, the solution according to the disclosure also lends itself to be applied in a classic environment that is not service-based.

Similar considerations apply if the program (which may be used to implement each embodiment) is structured in a different way, or if additional modules or functions are provided. Likewise, the memory structures may be of other types, or may be replaced with equivalent entities (not necessarily consisting of physical storage media). In any case, the program may take any form suitable to be used by or in connection with any data processing system, such as external or resident software, firmware, or microcode (either in object code or in source code - for example, to be compiled or interpreted).

Embodiments may take the form of an entirely hardware embodiment, an entirely software embodiment or an embodiment containing both hardware and software elements. An embodiment that is implemented in software may include, but is not limited to, firmware, resident software, microcode, etc.

Furthermore, embodiments may take the form of a computer program product accessible from a computer-usable or computer-readable medium providing program code for use by or in connection with a computer or any instruction execution system. For the purposes of this description, a medium can be any element suitable to participate in containing, storing, communicating, propagating, or transferring the program for use by or in connection with the instruction execution system, apparatus, or device.

The medium can be an electronic, magnetic, optical, electromagnetic, infrared, or semiconductor system, (or apparatus or device) or a propagation medium. Examples of a computer-readable medium include a semiconductor or solid state memory, magnetic tape, a removable computer diskette, a random access memory (RAM), a read-only memory (ROM), a rigid magnetic disk and an optical disk. Current examples of optical disks include compact disk-read only memory (CD-ROM), compact disk-read/write (CD-R/W) and DVD.

A data processing system suitable for storing and/or executing program code may include at least one processor coupled directly or indirectly to memory elements through a system bus. The memory elements can include local memory employed during actual execution of the program code, bulk storage, and cache memories which provide temporary storage of at least some program code in order to reduce the number of times code is retrieved from bulk storage during execution.

Input/output or I/O devices (including but not limited to keyboards, displays, pointing devices, etc.) can be coupled to the system either directly or through intervening I/O controllers.

Network adapters may also be coupled to the system to enable the data processing system to become coupled to other data processing systems or remote printers or storage devices through intervening private or public networks. Modems, cable modems and Ethernet cards are just a few of the currently available types of network adapters.

The proposed method may be carried out on a system having a different architecture or including equivalent units (for example, based on a local network). Moreover, each computer may include similar elements (such as cache memories temporarily storing the programs or parts thereof to reduce the accesses to the mass memory during execution). In any case, it is possible to replace the computer with any code execution entity (such as a PDA, a mobile phone, and the like), or with a combination thereof (such as a multi-tier server architecture, a grid computing infrastructure, and the like).

The terminology used herein is for the purpose of describing particular embodiments only and is not intended to be limiting of the disclosure. As used herein, the singular forms “a”, “an” and “the” are intended to include the plural forms as well, unless the context clearly indicates otherwise. It will be further understood that the terms “comprises” and/or “comprising,” when used in this specification, specify the presence of stated features, integers, steps, operations, elements, and/or components, but do not preclude the presence or addition of one or more other features, integers, steps, operations, elements, components, and/or groups thereof.

The corresponding structures, materials, acts, and equivalents of all means or step plus function elements in the claims below are intended to include any structure, material, or act for performing the function in combination with other claimed elements as specifically claimed. The description of the disclosure has been presented for purposes of illustration and description, but is not intended to be exhaustive or limited to the embodiments in the form disclosed. Many modifications and variations will be apparent to those of ordinary skill in the art without departing from the scope and spirit of the disclosure. The embodiment was chosen and described in order to best explain the principles of the disclosure and the practical application, and to enable others of ordinary skill in the art to understand the disclosure for various embodiments with various modifications as are suited to the particular use contemplated.

What is claimed is:

1. A method for balancing access to a shared resource in a data processing system by a plurality of exploiter entities, the method comprising:
associating a privilege limit for a privileged use of the shared resource with each one of a set of active entities;
measuring a use indicator for each active entity, the use indicator relating to actual use of the shared resource by the respective active entity;
detecting a critical condition of the shared resource;
upon receiving an access request for access to the shared resource by a new one of the active entities, releasing the access granted to at least one of a set of active entities currently accessing the shared resource; and
granting access to the new active entity.

2. The method of claim 1, wherein access is granted to the new active entity only if the use indicator of the new active entity has not reached the privilege limit.

3. The method of claim 1, wherein a maximum number of accesses is allowed concurrently to the shared resource, and wherein detecting the critical condition includes receiving an access request after reaching the maximum number of accesses.

4. The method of claim 1, wherein releasing the access granted to the at least one exploiter entity includes:
selecting one of the enabled entities having the corresponding use indicator closest to the privilege limit; and
releasing the access granted to the selected enabled entity.

5. The method of claim 1, further comprising conditioning the releasing of the access granted to the at least one enabled entity to a releasing condition.

6. The method of claim 1, wherein the shared resource includes a server adapted to offer a service, wherein each entity includes a client adapted to exploit the service and each access request includes a service request for exploiting the service, wherein each active entity includes an enabled client currently exploiting the service, and wherein a handle of a working session is allocated for each enabled client.

7. The method of claim 6, wherein granting access to the new active entity includes allocating a corresponding new handle to the enabled client of the new active entity.

8. The method of claim 7, wherein releasing the access granted to at least one of a set of active entities currently accessing the shared resource includes releasing each corresponding handle.

9. The method of claim 8, wherein allocating a corresponding new handle to the enabled client of the new active entity further comprises using a handle previously allocated to another client, if available.

10. The method of claim 6, wherein each working session includes the maintenance of context information of corresponding enabled clients for exploiting the service.

11. The method of claim 10, wherein granting access to the new active entity includes loading any corresponding context information.

12. The method of claim 11, wherein releasing the access granted to at least one of a set of active entities currently accessing the shared resource includes discarding any corresponding context information.

13. The method of claim 10, wherein associating a privilege limit for a privileged use of the shared resource with each one of a set of active entities further comprises:
receiving a connection request from an active client;
collecting context information of the active client;
creating a token for authorizing the active client to exploit the service, wherein the token is associated with the privilege limit of the active client initialized to a starting value; and
storing the collected context information of the active client into a profile associated with the token.

14. The method of claim 13, wherein granting access to the new active entity further comprises:
associating a new handle with the token;
retrieving any corresponding context information from the profile corresponding to the token.

15. The method of claim 14, wherein releasing the access granted to at least one of a set of active entities currently accessing the shared resource further comprises saving each corresponding context information into the profile of the corresponding token.

16. The method of claim 6, further comprising:
monitoring an activity of each enabled client; and
releasing each handle when an inactivity indicator of a corresponding enabled client reaches a first threshold.

17. A computer program product for balancing access to a shared resource in a data processing system by a plurality of exploiter entities, the computer program product comprising:
a computer-usable medium having computer usable program code embodied therewith, the computer usable program code comprising:
computer usable program code configured to:
associate a privilege limit for a privileged use of the shared resource with each one of a set of active entities;
measure a use indicator for each active entity, the use indicator relating to actual use of the shared resource by the respective active entity;
detect a critical condition of the shared resource;
release the access granted to at least one of a set of active entities currently accessing the shared resource upon receiving an access request for access to the shared resource by a new one of the active entities; and
grant access to the new active entity using the one or more servers.

18. A dispatching system for balancing access to a shared resource in a data processing system by a plurality of exploiter entities, the dispatching system comprising:
one or more servers configured to receive requests for access to the shared resource and to return corresponding responses;
one or more storage devices configured to store information;
a dispatcher coupled to the one or more servers and to the one or more storage devices;
wherein the dispatcher is configured to associate a privilege limit for a privileged use of the shared resource with each one of a set of active entities;
wherein the dispatcher is configured to measure a use indicator for each active entity, the use indicator relating to actual use of the shared resource by the respective active entity;
wherein the dispatcher is configured to detect a critical condition of the shared resource;
wherein the dispatcher is configured to release the access granted to at least one of a set of active entities currently accessing the shared resource in response to the one or more servers receiving an access request for access to the shared resource by a new one of the active entities; and
wherein the dispatcher is configured to grant access to the new active entity.

19. The dispatching system claim 18, wherein a maximum number of accesses is allowed concurrently to the shared resource, and wherein detecting the critical condition includes receiving an access request after reaching the maximum number of accesses.

20. The method of claim 18, wherein the shared resource includes a server adapted to offer a service, wherein each entity includes a client adapted to exploit the service and each access request includes a service request for exploiting the service, wherein each active entity includes an enabled client currently exploiting the service, and wherein a handle of a working session is allocated for each enabled client.
